(19) United States
(12) Patent Application Publication
(10) Pub. No.: US 2013/0187593 A1
(43) Pub. Date: Jul. 25, 2013

(54) INTELLIGENT CHARGING SOLUTION FOR LARGE-SCALE BATTERY SYSTEMS WITH SCALABLE POWER OUTPUT

(71) Applicant: Electric Motor Werks, Inc., Palo Alto, CA (US)

(72) Inventor: Valery Miftakhov, San Mateo, CA (US)

(73) Assignee: Electric Motor Werks, Inc., Palo Alto, CA (US)

(21) Appl. No.: 13/672,587

(22) Filed: Nov. 8, 2012

Related U.S. Application Data
(60) Provisional application No. 61/557,423, filed on Nov. 9, 2011.

(51) Int. Cl. H02J 7/00

(52) U.S. Cl. CPC H02J 7/007
USPC 320/107

(57) ABSTRACT

A scalable battery charging system and a probe system for charging large-scale battery systems. System incorporates (1) a control board with an extensible universal sensor assembly to monitor all relevant input and output parameters, (2) extensible power stage that can be scaled to the arbitrary levels of power by stacking power modules, and (3) remote control and monitoring hardware and software. This inventive system allows for more automated, lower cost, and higher lifetime usage of the large-scale battery systems. It will also allow for better user experience through better control over the process and automation of the traditionally manual steps.

### CROSS-REFERENCE TO RELATED APPLICATIONS

The present patent application relies on and claims the benefit or priority of U.S. provisional patent application No. 61/557,423 filed Nov. 9, 2011, the entire disclosure of which is incorporated by reference herein.

### BACKGROUND OF THE INVENTION

1. Field of the Invention

The present invention relates generally to the field of energy storage and in particular to electric vehicle battery charging, and the electronic systems used in this process.

2. Description of the Related Art

Large energy storage systems in general and electric vehicles battery systems in particular incorporate arrays of electrochemical energy storage devices (batteries) electrically connected in a combination of series and parallel arrangements to arrive at the necessary system voltage and current capabilities. The batteries are complex layered structures consisting of several functional components: an anode, a cathode, and electrolyte. The electrochemical reactions within the battery structure allow it to store or supply electrical energy. This description is focused on the electrical energy storage cycle, also known as “charging”.

Every type of battery requires a different charging process (charge profile) specified by the manufacturer. Modern battery chemistries require complex charging profiles consisting of multiple steps. During each step, the charging system has to supply a tightly specified levels of voltage and current to the battery system. Furthermore, there are complex sets of conditions that need to be monitored to detect transition from one charging step to another. These types of conditions include, without limitation: voltage, current, rate of voltage rise/fall, rate of current rise/fall, battery temperature and rise/fall of same, and the like.

Furthermore, many manufacturers specify multiple charging profiles for the same battery model—each corresponding to different intended battery use and usage requirements. For example, letting the battery to fully discharge and then applying full charge maximizes the energy output of the battery but at the same time dramatically reduces its longevity (cycle life). The ideal charging system should, therefore, be capable of adjusting the charging profile to attain the required trade-offs among various battery performance characteristics.

The charging systems available in the marketplace today generally have inflexible, pre-programmed profiles for a specific battery type. The user generally has to engage with the charging system manufacturer to change the pre-set charging profile. Furthermore, it is not possible to seamlessly integrate the existing standalone charging systems into the end user installation (emergency home energy storage, electric vehicle battery, etc) without modifications from the manufacturer. Additionally, the available systems have fixed maximum power settings, limiting user's ability to scale up the charging power as needed. For example, a user might need 6 kW charging system to charge the electric car from widely available level 2 public charging stations but would like to extend that to 20 kW fast charge from his/her home electrical system. Today, this solution is not possible to implement without significant redundancy, weight, and cost (as two completely separate systems would be required).

### SUMMARY OF THE INVENTION

The inventive methodology is directed to methods and systems that substantially obviate one or more of the above and other problems associated with conventional techniques for electric vehicle battery charging, and the electronic systems used in this process.

In accordance with one aspect of the invention, there is provided a scalable charging system for a battery energy storage system, the charging system comprising: a microprocessor-based control system comprising an extensible universal sensor assembly and operable to monitor all relevant input and output parameters; an extensible power stage delivering energy to the battery energy storage system and operable to be scaled to the arbitrary levels of power by stacking power modules; and a remote control and monitoring hardware module executing a remote control and monitoring software.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary battery charging system in accordance with embodiments of the inventive concept.

FIG. 2 illustrates an exemplary embodiment of an inventive charging system depicting in detail its principal components and its charger stage schematics.

FIG. 3 illustrates an exemplary embodiment of an inventive charging system depicting in detail its principal components and is PCB design.

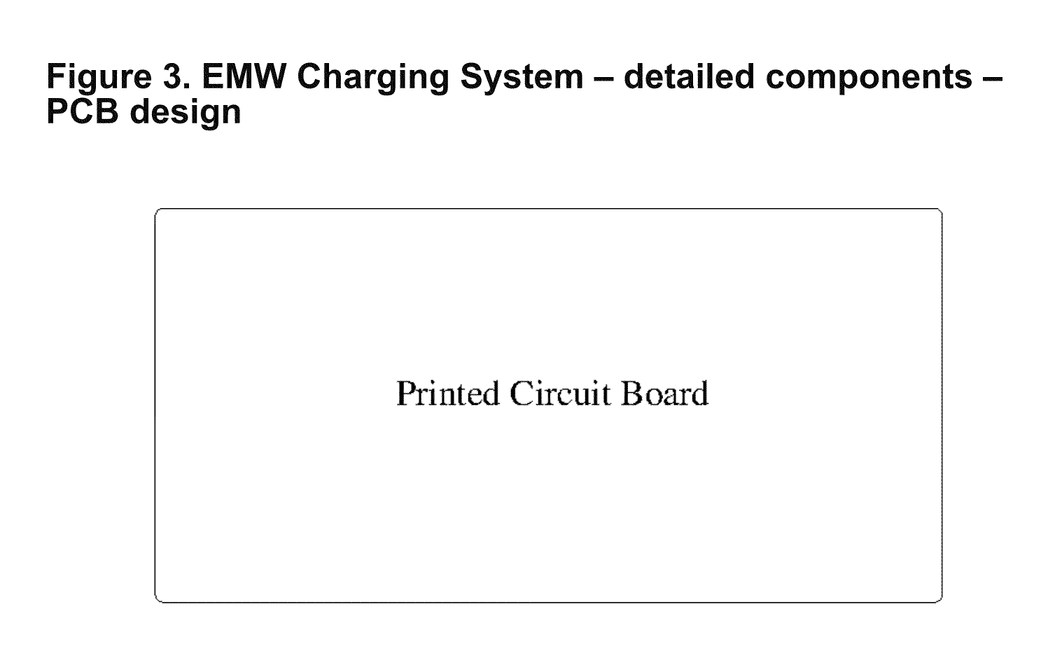

FIG. 4 illustrates an exemplary embodiment of an inventive charging system depicting in detail its principal components and its component layout.

FIG. 5 illustrates an exemplary embodiment of an inventive charging system depicting in detail its principal components and its external view.

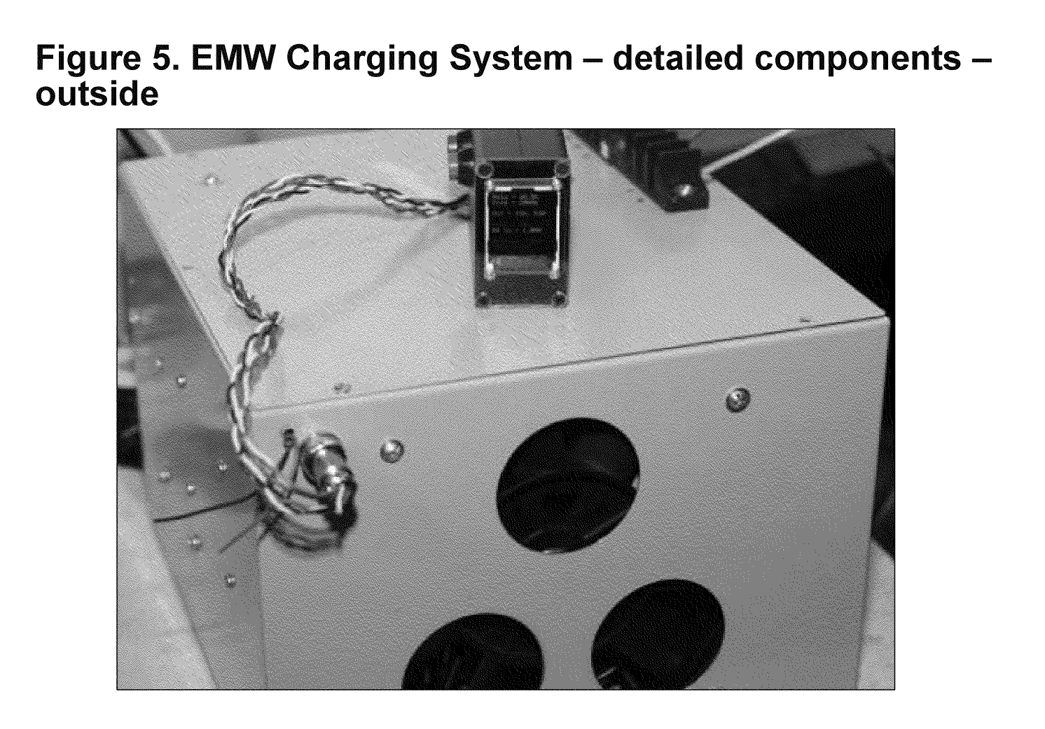

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense.

The inventive methodology is directed to methods and systems that substantially obviate one or more of the above and other problems associated with conventional techniques for charging large-scale (>10 kWhr) battery systems.

In accordance with one aspect of the present invention, there is provided an extensible hardware architecture providing necessary control functions and stackable power stages—allowing for virtually unlimited output power at much lower cost and complexity than any existing solutions.

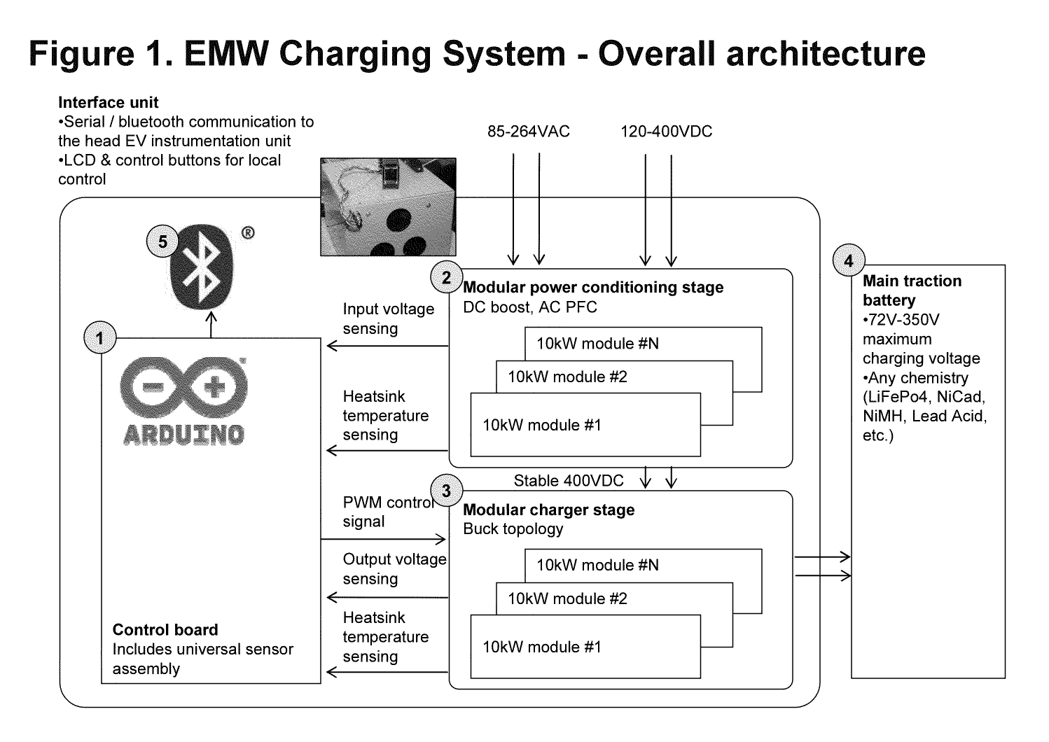

Various embodiments include a two-part architecture consisting of the microprocessor-based control system that performs all the control functions of the charging system functions, and the power stage that actually delivers energy to the energy storage system. An exemplary embodiment of the system is illustrated in FIG. 1.

Various embodiments include a power stage (FIG. 1, elements 2 & 3) to deliver any pre-set level of power to the energy storage system—limited only to the total power available from the primary power source (which, in turn, could be the power grid system or another energy storage system). In one exemplary implementation, the power stage is driven by the Pulse-Width-Modulated signal from the microprocessor-based control system (FIG. 1, element 1).

Various embodiments include a power stage consisting of two parts: (1) a power conditioning system (FIG. 1, element 2), and (2) a down-conversion stage converting the DC power from the power conditioning system into the form usable for the purposes of energy storage system being charged (FIG. 1, element 3).

Various embodiments include a power conditioning system (FIG. 1, element 3) ensuring high level of utilization of the available AC power. This utilizes a Power Factor Correction system that ensures a non-reactive load to the power grid, and provides a universal input voltage capability. Such a power factor correction system can be based on the standard stand-alone PFC management IC (Integrated Circuit) and operate as a continuous conduction boost topology and boosts the input voltage (110 VAC, 220 VAC, 400 VAC 3-phase, etc) to the standard boosted DC rail voltage (standard 600V rail is used in one of the embodiments).

In addition to conditioning the AC power, the aforementioned power conditioning system can be used to charge the batteries from a pure DC source such as a stationary battery bank, another Electric Vehicle, or even a small emergency power battery pack. This aspect of the invention allows to substantially increase utility of the charging system in the field and is significant component of the describe invention.

Various embodiments include a down-conversion stage (FIG. 1, element 2) based on the custom Pulse-Width-Modulation (PWM) control of the power IGBT switch, operating as a continuous conduction buck topology.

Various embodiments include a down-conversion stage that is capable of being paralleled to other instances of the power stage for stackable maximum power delivered to the energy storage system. Both PWM inputs, power inputs, and power outputs can be paralleled in the stacked configuration. In a preferred embodiment, power stages have guaranteed power-sharing capability to within 5-10% of each other.

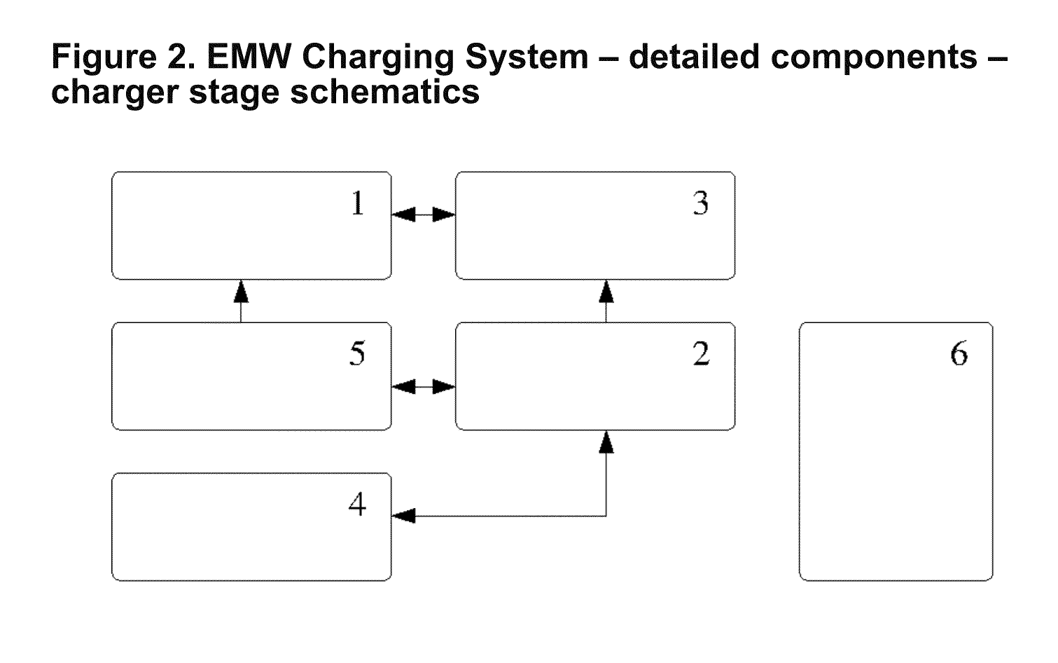

Various embodiments include IGBT driver circuits (FIG. 2, element 2) optimized to deliver the optimal levels of driving currents and transition timing. The PCB boards containing such circuits are to be placed directly on the IGBT switch devices to minimize stray inductances in the circuit—critical to ensure the reliable operation of the circuit at the required power levels.

Various embodiments include a microprocessor-based control system capable of controlling an arbitrary number of the power stages.

Various embodiments include a microprocessor-based control system incorporating a universal set of sensors to monitor all possible parameters necessary for charging profile administration—including voltage, current, temperature.

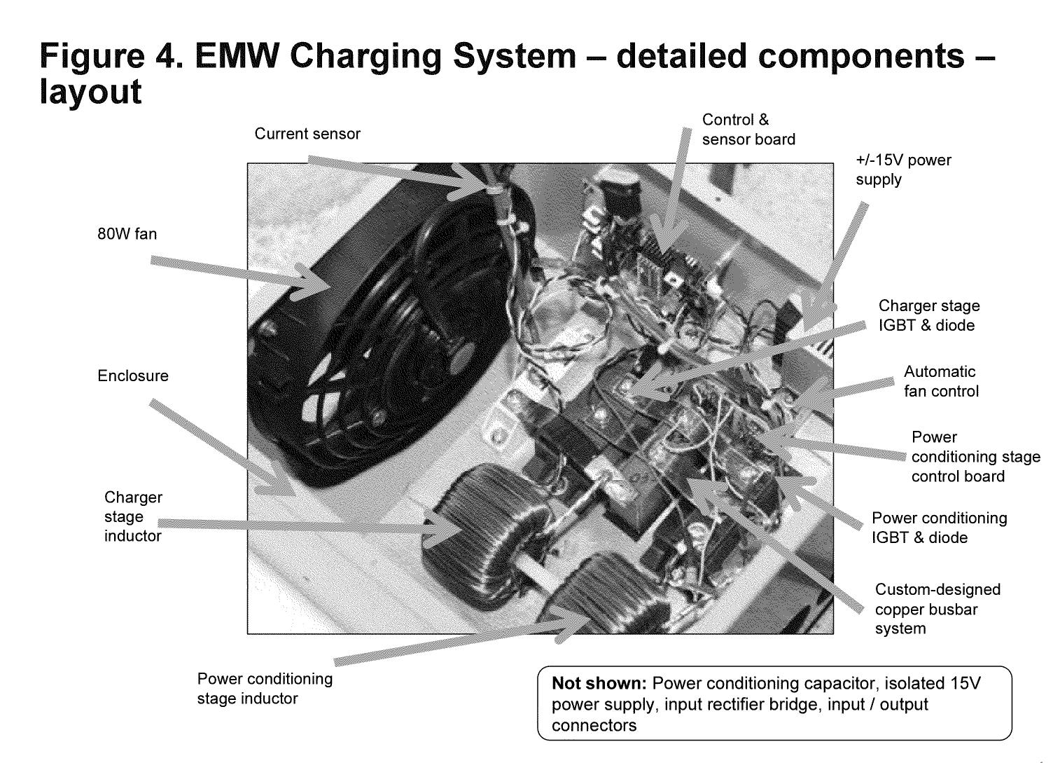

Various embodiments include a set of sensor attachments (FIG. 4) allowing extensions of the measurable parameters into an arbitrary set of additional parameters. Such attachments can provide ability to modify the charging profile based on various environmental factors—for example, an attachment may be used to terminate the charge on the external analog voltage signal from one or more of the batteries in the battery pack, etc.

Various embodiments include a hardware-based maximum output current control (FIG. 2, element 5) that filters the output switching signal from the microprocessor according to the instantaneous output current. This system receives the signal from the microprocessor that defines the output current threshold, thus making the current control system fully programmable through the microcontroller system.

Various embodiments include a temperature management system (FIG. 2, element 3) that controls the operating parameters of the overall charging system based on the instantaneous temperature of one or more of the charging system components. Such a system derates the charger output according to the pre-set temperature profile to protect the power components of the charger system and minimize temperature-related sensor deviations.

Various embodiments include an interface system connected to the micro-processor control board (FIG. 1, element 5). Such an interface system controls all the charging parameters and is used to set the appropriate charging profiles. Such an interface system consists of an LCD screen and a small keyboard to accept user inputs.

Various embodiments include an interface system with provision for remote charger management (FIG. 1, element 5). Such system can be set up to connect to external consumer electronics devices (phones, PCs, etc.) equipped with appropriate user interface software. Such a system would enable users to monitor and program the charging system wirelessly in the proximity of the system (e.g., from one of the rooms in the house while the vehicle battery is being charged in the garage, etc.). Furthermore, the specialized software provided for the consumer device can enable the connection of the charging system to the Internet, enabling true remote monitoring/control functionality.

It is to be understood that both the foregoing and the following descriptions are exemplary and explanatory only and are not intended to limit the claimed invention or application thereof in any manner whatsoever.

As it would be appreciated by those of skill in the art, the advantages of the inventive Charging System described herein include the reduced downtime for battery recharge, reduced cost of charging the batteries from ability to time the charge to the time of day with the lowest cost of electricity, as well as increased lifetime of the batteries from better charging cycle management.

It should be noted that the inventive procedure and associated mechanism for remotely (and/or automatically) reconfiguring charging profiles is not limited to any specific testing device or any specific testing system or method. The described concepts may be used in charging any type of batteries for any type of application from any external electric energy source.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive.

Moreover, other implementations of the invention will be apparent to those skilled in the art from consideration of the specification and practice of the invention disclosed herein. Various aspects and/or components of the described embodiments may be used singly or in any combination in the system for charging large-scale (>10 kWhr) battery systems. It is intended that the specification and examples be considered as exemplary only, with a true scope and spirit of the invention being indicated by the following claims.

What is claimed is:

1. A scalable charging system for a battery energy storage system, the charging system comprising:
a. a microprocessor-based control system comprising an extensible universal sensor assembly and operable to monitor all relevant input and output parameters;
b. an extensible power stage delivering energy to the battery energy storage system and operable to be scaled to the arbitrary levels of power by stacking power modules; and
c. a remote control and monitoring hardware module executing a remote control and monitoring software.

2. The scalable charging system of claim 1, wherein the microprocessor-based control system is operable to generate a Pulse-Width-Modulated signal and wherein the extensible power stage is driven by the Pulse-Width-Modulated signal provided by the microprocessor-based control system.

3. The scalable charging system of claim 1, wherein the extensible power stage comprises a power conditioning system and a down-conversion stage for converting a DC power from the power conditioning system into a form usable for the purposes of the battery energy storage system being charged.

4. The scalable charging system of claim 3, wherein the power conditioning system comprises a Power Factor Correction system operable to ensure a non-reactive load to the power grid and provide a universal input voltage capability.

5. The scalable charging system of claim 1, wherein the extensible power stage comprises a down-conversion stage based on a custom Pulse-Width-Modulation (PWM) control of a power IGBT switch, operating as a continuous conduction buck topology.

6. The scalable charging system of claim 5, further comprising an IGBT driver circuit operable to deliver the optimal levels of driving currents and transition timing.
